(19) United States
(12) Patent Application Publication
(10) Pub. No.: US 2026/0341579 A1
(43) Pub. Date: Oct. 29, 2026

(54) COIL COMPONENT

(71) Applicant: Murata Manufacturing Co., Ltd., Kyoto-fu (JP)

(72) Inventor: Yutaka NOGUCHI, Nagaokakyo-shi (JP)

(73) Assignee: Murata Manufacturing Co., Ltd., Kyoto-fu (JP)

(21) Appl. No.: 19/707,028

(22) Filed: Jun. 12, 2026

Related U.S. Application Data
(63) Continuation of application No. PCT/JP2024/037197, filed on Oct. 18, 2024.

(30) Foreign Application Priority Data
Jan. 30, 2024 (JP) 2024-011764

(51) Int. Cl. H01F 27/28; H01F 27/29

(52) U.S. Cl. CPC H01F 27/2809; H01F 27/292

(57) ABSTRACT

A coil component reduces occurrence of cracks in the vicinity of an interface with a coil inside an element body. The coil component includes an element body including a magnetic material containing Fe; a coil embedded in the element body; and an outer electrode provided on a mounting surface of the element body and electrically connected to the coil. The coil includes a plurality of coil conductors electrically connected together in a stacking direction. The element body includes a contact layer that is in contact with one of the coil conductors and a non-contact layer that is not in contact with any one of the coil conductors, and the contact layer contains an oxidation-inhibiting material that inhibits oxidation of Fe.

### CROSS-REFERENCE TO RELATED APPLICATIONS

This application claims benefit of priority to International Patent Application No. PCT/JP2024/037197, filed Oct. 18, 2024, and to Japanese Patent Application No. 2024-011764, filed Jan. 30, 2024, the entire contents of each are incorporated herein by reference.

### BACKGROUND

### Technical Field

The present disclosure relates to a coil component.

### Background Art

Japanese Unexamined Patent Application Publication No. 2012-164958 discloses a coil component of a type in which a spiral coil portion covered with a magnetic portion is in direct contact with the magnetic portion, wherein the coil portion contains Ag, and the magnetic portion includes Fe—Cr—Si alloy particles.

### SUMMARY

In the coil component described in Japanese Unexamined Patent Application Publication No. 2012-164958, a heat treatment is performed on an element body by using a firing furnace or the like. By this heat treatment, Fe—Cr—Si alloy particles constituting the element body are coupled to each other via oxide films formed on respective surfaces of the alloy particles. The oxide films are formed prominently on the surfaces of the Fe—Cr—Si alloy particles particularly in the vicinity of interfaces thereof with the coil portion containing Ag, leading to an improvement in adhesion strength between the coil portion and the alloy particles. Further, in the coil component described in Japanese Unexamined Patent Application Publication No. 2012-164958, when the element body is subjected to the heat treatment, the magnetic portion containing the Fe—Cr—Si alloy particles is less likely to undergo firing shrinkage, but the coil portion is more likely to undergo firing shrinkage. Therefore, in the coil component described in Japanese Unexamined Patent Application Publication No. 2012-164958, cracks may occur in the vicinity of a contact interface between the magnetic portion and the coil portion due to a mismatch in shrinkage behavior therebetween.

The inventor of the present application has found the causes of occurrence of such cracks as follows. Metal magnetic particles constituting the magnetic body contain Fe as a main component and have a greater ionization tendency than Ag constituting the coil. Thus, in a region in the vicinity of the interface where the coil portion contacts the metal magnetic particles, Ag constituting the coil is reduced during the heat treatment. This reduction easily accelerates oxidation of the metal magnetic particles, which contain Fe as the main component and constitute the magnetic body in the vicinity of the coil, thereby improving adhesion strength. Therefore, during the heat treatment, the magnetic portion, which is less likely to undergo firing shrinkage, is pulled by the firing shrinkage of the coil portion, whereby cracks may occur due to the mismatch in shrinkage behavior and the improved adhesion strength.

Accordingly, the present disclosure provides a coil component capable of reducing occurrence of cracks in the vicinity of an interface with a coil inside an element body.\A coil component according to the present disclosure includes an element body including a magnetic material containing Fe; a coil embedded in the element body; and an outer electrode provided on a mounting surface of the element body and electrically connected to the coil. The coil includes a plurality of coil conductors electrically connected together in a stacking direction. The element body includes a contact layer that is in contact with one of the coil conductors and a non-contact layer that is not in contact with any one of the coil conductors, and the contact layer contains an oxidation-inhibiting material that inhibits oxidation of Fe.

According to the present disclosure, it is possible to provide a coil component capable of reducing occurrence of cracks in the vicinity of an interface with a coil inside an element body.

### BRIEF DESCRIPTION OF THE DRAWINGS

FIG. 1 is a perspective view of a coil component of the present disclosure;

FIG. 2 is an exploded perspective view of the coil component according to a first embodiment of the present disclosure;

FIG. 3 is a sectional view taken along line III-III of FIG. 2 in the arrow direction;

FIG. 4 is an enlarged sectional view of a region surrounded by a dashed line in FIG. 3;

FIG. 5 is an enlarged sectional view of a coil component according to a second embodiment;

FIG. 6 is a sectional view of a coil component according to a third embodiment; and

FIG. 7 is an enlarged sectional view of a region surrounded by a dashed line in FIG. 6.

### DETAILED DESCRIPTION

Hereinafter, a coil component of the present disclosure will be described. The present disclosure is not limited to the following configurations and may be modified as appropriate without departing from the gist of the present disclosure. A combination of a plurality of preferred configurations described below also falls within the scope of the present disclosure.

The coil component of the present disclosure is used, for example, in a DC-DC converter. The coil component of the present disclosure is also applicable to uses other than DC-DC converters.

In the present specification, terms indicating relationships between elements (for example, “parallel”, “orthogonal”, and the like) and terms indicating shapes of elements are not limited to strictly literal meanings, but also include substantially equivalent ranges, for example, ranges including differences of about several percent. Note that in the present specification, a direction in which magnetic layers and coil conductors constituting the element body are stacked is defined as a “stacking direction”.

Further, in the description of the present specification, references to directions, orientations, or the like are merely for convenience of explanation and are not intended to limit the scope of the present disclosure unless otherwise explicitly stated. For example, relative terms such as “outer (or outside, external, or outer periphery)” and “inner (or inside, internal, or inner periphery)”, and derivatives thereof should be interpreted as referring to directions as described or illustrated. That is, unless otherwise explicitly stated, the disclosure is not required to be limited to any specific direction, orientation, form, or the like. The same applies to terms such as “provided”, “disposed”, and “connected”, and derivatives thereof. Unless otherwise explicitly stated, these terms are not limited to direct modes and may include modes in which other elements, such as inclusions, are interposed.

The drawings shown below are schematic diagrams, and their dimensions, scales including aspect ratios, and the like may differ from those of actual products.

### Coil Component of First Embodiment

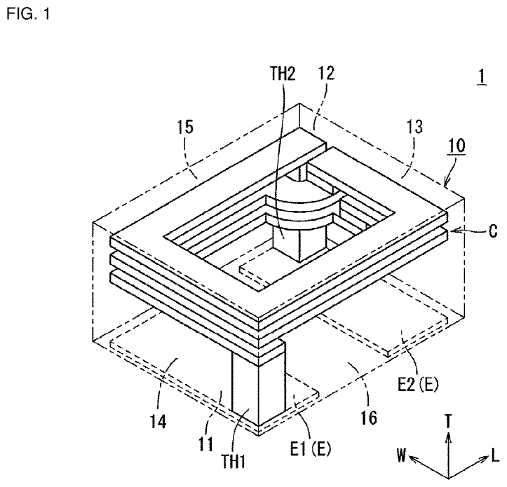

A coil component according to a first embodiment of the present disclosure will be described with reference to FIGS. 1 to 4. A coil component 1 of the present disclosure includes an element body 10, a coil C, and outer electrodes E.

### Element Body

The element body 10 has, for example, a rectangular parallelepiped shape or a substantially rectangular parallelepiped shape having six surfaces. The element body 10 may have a corner or ridge that is rounded. The corner is a portion where three surfaces of the element body 10 meet, and the ridge is a portion where two surfaces of the element body 10 meet.

In FIG. 1, the length direction, the width direction, and the height direction of the coil component 1 and the element body 10 are indicated as an L direction, a W direction, and a T direction, respectively. The length direction L, the width direction W, and the height direction T are orthogonal to each other. A mounting surface of the coil component 1 is, for example, a surface (LW surface) parallel to the length direction L and the width direction W.

The element body 10 shown in FIG. 1 has a first main surface 11 and a second main surface 12 opposed to each other in the height direction T, a first side surface 15 and a second side surface 16 opposed to each other in the width direction W, and a first end surface 13 and a second end surface 14 opposed to each other in the length direction L. In the example shown in FIG. 1, the first main surface 11 of the element body 10 corresponds to the mounting surface (bottom surface) of the element body 10. Note that the second main surface 12 may instead be the mounting surface of the element body 10. When the second main surface 12 is used as the mounting surface of the element body 10, a through-hole conductor TH, which will be described later, connected to the outer electrode E may be derived toward the second main surface 12.

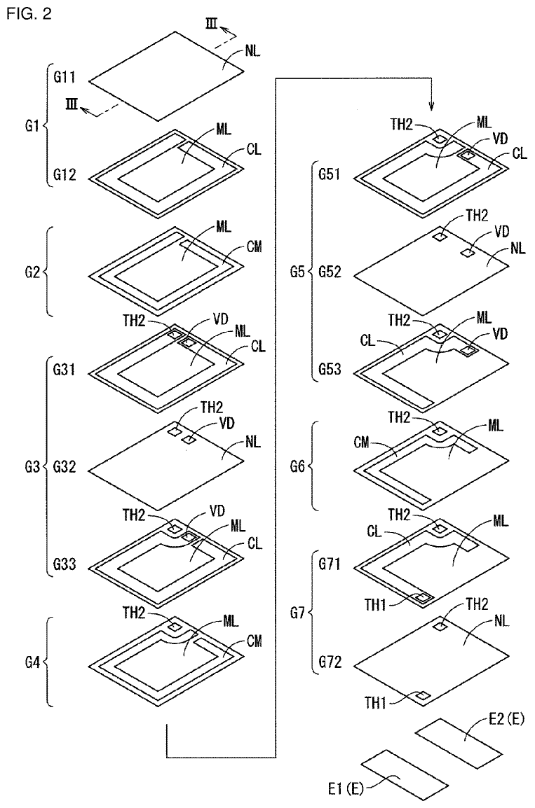

The element body 10 has a multilayer structure in which a plurality of element body layers, each including a magnetic layer ML and a coil conductor CM, are stacked in the stacking direction (for example, the height direction T). In the present embodiment, as shown in FIG. 2, the element body 10 is formed by stacking element body layers G1 to G7. A coil is formed by stacking a plurality of coil conductors CM. By forming the coil by stacking the coil conductors CM, the coil can be made smaller than a winding-type coil formed by winding a conductive wire. Note that the boundaries between the respective layers of the multilayer structure included in the element body 10 become indistinct. The number of stacked layers is not limited to the number of element body layers G1 to G7, and may be greater than or equal to this number or may be less than or equal to this number, depending on the number of turns of the coil. Further, each of the element body layers G1 to G7 may be formed by stacking a plurality of layers as appropriate so as to have a predetermined thickness according to its characteristics.

### Element Body Layer G1

As shown in FIG. 2, the element body layer G1 includes a layer G11 and a layer G12.

### Layer G11

The layer G11 is a layer that constitutes the second main surface 12 of the element body 10. The layer G11 is not in contact with a coil conductor (for example, the coil conductor CM of the element body layer G2) and thus corresponds to a non-contact layer. The layer G11 is formed by a magnetic layer (non-contact layer NL) containing Fe. In other words, the non-contact layer NL may be formed of the same material as the magnetic layer ML described later.

### Layer G12

The layer G12 includes a contact layer CL that is in contact with the coil conductor CM of the element body layer G2. A magnetic layer ML may be provided around the contact layer CL in plan view. The magnetic layer ML will be described in detail later.

The contact layer CL is provided corresponding to a winding shape of the coil conductor CM of the element body layer G2. In perspective plan view, the plane area of the contact layer CL is designed to be larger than that of the coil conductor CM of the element body layer G2. In other words, the contact layer CL may include a region that is in contact with the coil conductor CM and a region that extends beyond the coil conductor CM in the perspective plan view.

### Element Body Layer G2

The element body layer G2 may include the coil conductor CM constituting a portion of the coil, and the magnetic layer ML disposed around the coil conductor CM.

The coil conductor CM of the element body layer G2 constitutes one turn of the coil. More specifically, the coil conductor CM is disposed along a substantially outer peripheral edge of the magnetic layer ML. One end of the coil conductor CM is connected to a via conductor VD of the element body layer G3, while the other end of the coil conductor CM is connected to a second through-hole conductor TH2 for electrical connection with a second outer electrode E2.

### Element Body Layer G3

As shown in FIG. 2, the element body layer G3 includes a layer G31, a layer G32, and a layer G33.

### Layer G31

The layer G31 includes the contact layer CL in contact with the coil conductor CM of the element body layer G2, the magnetic layer ML disposed around the contact layer CL, and the via conductor VD and the second through-hole conductor TH2.

The contact layer CL is provided corresponding to the winding shape of the coil conductor CM of the element body layer G2. In perspective plan view, the plane area of the contact layer CL is designed to be larger than that of the coil conductor CM of the element body layer G2.

The via conductor VD is disposed so as to be connected to one end of the coil conductor CM of the element body layer G2. In FIG. 2, the above-described contact layer CL is disposed around the via conductor VD. However, the above-described contact layer CL does not need to be disposed around the via conductor VD.

The second through-hole conductor TH2 connects the second through-hole conductors TH2 of the element body layers G2 and G4 that are adjacent to each other in the stacking direction, and is in electrical continuity with the second outer electrode E2. In FIG. 2, the above-described contact layer CL is disposed around the second through-hole conductor TH2. However, the above-described contact layer CL does not need to be disposed around the second through-hole conductor TH2.

### Layer G32

The layer G32 includes the magnetic layer (non-contact layer NL), the via conductor VD, and the second through-hole conductor TH2. That is, the layer G32 corresponds to a non-contact layer that is not in contact with the coil conductor CM. The via conductor VD and the second through-hole conductor TH2 in the layer G32 are disposed corresponding to the via conductor VD and the second through-hole conductor TH2 in the layer G31, respectively.

### Layer G33

The layer G33 includes the contact layer CL in contact with the coil conductor CM of the element body layer G4, the magnetic layer ML disposed around the contact layer CL, the via conductor VD and the second through-hole conductor TH2.

The contact layer CL is provided corresponding to the winding shape of the coil conductor CM of the element body layer G4. In perspective plan view, the plane area of the contact layer CL is designed to be larger than that of the coil conductor CM of the element body layer G4.

The via conductor VD and the second through-hole conductor TH2 in the layer G33 are disposed corresponding to the via conductor VD and the second through-hole conductor TH2 in the layer G32, respectively. In FIG. 2, the contact layer CL is disposed around the via conductor VD of the layer G33. However, the contact layer CL does not need to be disposed around the via conductor VD of the layer G33.

### Element Body Layer G4

The element body layer G4 includes the coil conductor CM constituting a portion of the coil, the magnetic layer ML disposed around the coil conductor CM, and the second through-hole conductor TH2.

The coil conductor CM of the element body layer G4 constitutes one turn of the coil. More specifically, the coil conductor CM is disposed along a substantially outer peripheral edge of the magnetic layer ML. One end of the coil conductor CM is connected to the via conductor VD of the element body layer G3, while the other end of the coil conductor CM is connected to the via conductor VD of the element body layer G5.

The second through-hole conductor TH2 connects the second through-hole conductors TH2 of the element body layers G3 and G5 adjacent in the stacking direction, and is in electrical continuity with the second outer electrode E2.

### Element Body Layer G5

As shown in FIG. 2, the element body layer G5 includes a layer G51, a layer G52, and a layer G53.

### Layer G51

The layer G51 includes the contact layer CL in contact with the coil conductor CM of the element body layer G4, the magnetic layer ML disposed around the contact layer CL, the via conductor VD, and the second through-hole conductor TH2.

The contact layer CL is provided corresponding to the winding shape of the coil conductor CM of the element body layer G4. In perspective plan view, the plane area of the contact layer CL is designed to be larger than that of the coil conductor CM of the element body layer G4.

The via conductor VD is positioned so as to be connected to the other end of the coil conductor CM of the element body layer G4. In FIG. 2, the above-described contact layer CL is disposed around the via conductor VD. However, the above-described contact layer CL does not need to be disposed around the via conductor VD.

The second through-hole conductor TH2 connects the second through-hole conductors TH2 of the element body layers G4 and G6 adjacent in the stacking direction, and is in electrical continuity with the second outer electrode E2.

### Layer G52

The layer G52 includes the magnetic layer (non-contact layer NL), the via conductor VD, and the second through-hole conductor TH2. That is, the layer G52 corresponds to a non-contact layer that is not in contact with the coil conductor CM. The via conductor VD and the second through-hole conductor TH2 in the layer G52 are disposed corresponding to the via conductor VD and the second through-hole conductor TH2 in the layer G51, respectively.

### Layer G53

The layer G53 includes the contact layer CL in contact with the coil conductor CM of the element body layer G6, the magnetic layer ML disposed around the contact layer CL, the via conductor VD, and the second through-hole conductor TH2.

The contact layer CL is provided corresponding to the winding shape of the coil conductor CM of the element body layer G6. In perspective plan view, the plane area of the contact layer CL is designed to be larger than that of the coil conductor CM of the element body layer G6.

The via conductor VD and the second through-hole conductor TH2 in the layer G53 are disposed corresponding to the via conductor VD and the second through-hole conductor TH2 in the layer G52, respectively. In FIG. 2, the contact layer CL is disposed around the via conductor VD of the layer G53. However, the contact layer CL does not need to be disposed around the via conductor VD of the layer G53.

### Element Body Layer G6

The element body layer G6 includes the coil conductor CM constituting a portion of the coil, the magnetic layer ML disposed around the coil conductor CM, and the second through-hole conductor TH2.

The coil conductor CM of the element body layer G6 constitutes one turn of the coil. More specifically, the coil conductor CM is disposed along a substantially outer peripheral edge of the magnetic layer ML. One end of the coil conductor CM is connected to the via conductor VD of the element body layer G5, while the other end of the coil conductor CM is connected to a first through-hole conductor TH1 of the element body layer G7.

The second through-hole conductor TH2 connects the second through-hole conductors TH2 of the element body layers G5 and G7 adjacent in the stacking direction, and is in electrical continuity with the second outer electrode E2.

### Element Body Layer G7

As shown in FIG. 2, the element body layer G7 includes a layer G71 and a layer G72.

### Layer G71

The layer G71 includes the contact layer CL in contact with the coil conductor CM of the element body layer G6, the magnetic layer ML disposed around the contact layer CL, the second through-hole conductor TH2, and the first through-hole conductor TH1.

The contact layer CL is provided corresponding to the winding shape of the coil conductor CM of the element body layer G6. In perspective plan view, the plane area of the contact layer CL is designed to be larger than that of the coil conductor CM of the element body layer G6.

The second through-hole conductor TH2 is connected to the adjacent second through-hole conductor TH2 of the element body layer G6 in the stacking direction, and is in electrical continuity with the second outer electrode E2.

The first through-hole conductor TH1 is connected to the adjacent first through-hole conductor TH1 of the element body layer G6 in the stacking direction, and is in electrical continuity with the first outer electrode E1. In FIG. 2, the contact layer CL is disposed around the first through-hole conductor TH1. However, the contact layer CL does not need to be disposed around the first through-hole conductor TH1.

### Layer G72

The layer G72 includes the magnetic layer (non-contact layer NL), the first through-hole conductor TH1, and the second through-hole conductor TH2. The layer G72 is a layer that constitutes the first main surface 11 of the element body 10 and is similar to the non-contact layer NL. Specifically, the layer G72 is formed by a magnetic layer. The first through-hole conductor TH1 and the second through-hole conductor TH2 of the layer G72 are disposed corresponding to the first through-hole conductor TH1 and the second through-hole conductor TH2 of the layer G71, respectively.

As described above, when the element body 10 has a multilayer structure including the element body layers G1 to G7, the degree of freedom in design of the coil component 1 becomes higher. For example, when the coil component 1 including the first outer electrode E1 and the second outer electrode E2 on its bottom surface (first main surface 11) of the element body 10 is manufactured, it becomes easier to derive the coil toward the bottom surface side. Note that the multilayer structure including the above-described element body layers G1 to G7 may be formed by sequentially stacking layers by printing (for example, screen printing) from the second main surface 12 side or the first main surface 11 side of the element body 10. In this case, each of the element body layers G1 to G7 may be formed by repeated printing until a desired thickness is reached.

The magnetic layer ML of each of the element body layers G1 to G7 includes metal magnetic particles MP formed of a magnetic material and a resin (see FIG. 4). The metal magnetic particles MP include metal particles and oxide layers formed on surfaces of the respective metal particles, and adjacent metal magnetic particles MP are coupled to each other via the oxide layer. After the heat treatment of the element body, the resin with which the element body is impregnated is present in portions of the element body other than regions where adjacent metal magnetic particles MP are coupled via the oxide layer and in portions of the element body located around the metal magnetic particles MP where no oxide layer is present.

The average particle size of the metal magnetic particles MP is preferably 0.2 μm or more and 50 μm or less (i.e., from 0.2 μm to 50 μm), more preferably 2 μm or more and 30 μm or less (i.e., from 2 μm to 30 μm), and still more preferably 2 μm or more and 20 μm or less (i.e., from 2 μm to 20 μm). When the average particle size of the metal magnetic particles MP is relatively small as in the above numerical ranges, the number of metal magnetic particles MP can be increased. As a result, the number of portions where the metal magnetic particles MP are insulated from each other by the oxide layers described later can increase, thereby improving insulation.

The average particle size of the metal magnetic particles MP can be measured by the procedure described below. A sample of a coil component is cut to obtain a sample cross-section. Specifically, the sample is cut so as to pass through a central portion of the element body and an axis of winding of the coil in a direction orthogonal to the mounting surface and an end surface of the element body, thereby obtaining the sample cross-section. Note that the sample cross-section may be made flat by ion milling or the like. With respect to the obtained cross-section, any three locations in a central portion of the element body 10 are imaged by SEM (at a magnification of about 1000 to 5000). Then, for the confirmed metal magnetic particles MP, an average particle size of the metal magnetic particles MP is determined using image analysis software (for example, image analysis software WinROOF2021 manufactured by Mitani Corporation). The average particle size referred to in the present specification may mean an average particle size D50 (particle size corresponding to a cumulative percentage of 50% on a volume basis).

The metal particles contain Fe (iron) and Si. More specifically, the metal particles may be particles or alloy particles containing Fe and Si. Examples of materials for the metal particles may include Fe—Si-based alloys, Fe—Si—Cr (chromium)-based alloys, Fe—Si—Al (aluminum)-based alloys, Fe—Si—B (boron)-P (phosphorus)-Cu (copper)-C (carbon)-based alloys, Fe—Si—B—Nb (niobium)-Cu-based alloys, and the like. The metal particles may also contain impurities such as Cr, Mn (manganese), Cu, Ni (nickel), P, S (sulfur), or Co (cobalt), which are not intentionally introduced in manufacturing. By causing the metal particles to contain Si, the oxidation of the Fe element contained in the metal particles is suppressed. This makes it possible to further enhance the magnetic permeability of the coil component 1. The metal magnetic particles may be included in a magnetic paste for forming the magnetic layer. Therefore, the metal particles may contain an element that is more easily oxidized than Fe (for example, Cr, Al, Li (lithium), or Zn (zinc)) and that is added during preparation of the magnetic paste. By adding, to the magnetic paste, the element that is more easily oxidized than Fe, during heat treatment of the element body, the element that is more easily oxidized than Fe is oxidized first to form an oxide, thereby making it possible to suppress the oxidation of the Fe element contained in the metal particles. A resin component contained in the magnetic paste may disappear by the heat treatment of the element body or may remain.

The surfaces of the metal particles described above are covered with the oxide layers. When the surfaces of the metal particles are covered with the oxide layers, insulation between the metal particles can be enhanced.

The oxide layer is a layer formed by oxidation of the metal particles. That is, the oxide layer may contain an oxygen element. The thickness of the oxide film is preferably 1 nm or more and 50 nm or less (i.e., from 1 nm to 50 nm), more preferably 1 nm or more and 30 nm or less (i.e., from 1 nm to 30 nm), and still more preferably 1 nm or more and 20 nm or less (i.e., from 1 nm to 20 nm). For example, the cross-section obtained by ion milling the sample of the coil component is imaged with a scanning electron microscope (SEM) or a transmission electron microscope (TEM), and the thickness of the oxide film covering the surface of the metal particle can be measured from the obtained SEM image.

In order to increase the strength of the element body 10, the element body formed by stacking the above-described element body layers may be subjected to the heat treatment and then impregnated with the resin, thereby allowing the resin to be present in voids between the metal magnetic particles MP. By way of example, the resin with which the element body is impregnated after the heat treatment may be one or more resins selected from the group consisting of an epoxy resin, a phenol resin, a polyester resin, a polyimide resin, a polyolefin resin, a silicone resin, an acrylic resin, a polyvinyl butyral resin, a cellulose resin, an alkyd resin, and other similar resins.

### Characteristic Configuration of Element Body

The element body 10 of the present disclosure includes the non-contact layers NL that are not in contact with the coil conductors CM and the contact layers CL that are in contact with the coil conductors CM (see FIG. 4).

The non-contact layer NL corresponds to each of the layer G11, the layer G32, the layer G52, and the layer G72 in the element body layers G1 to G7 shown in FIG. 2. The non-contact layer NL includes the metal magnetic particles MP described above. Thus, as compared with the contact layer CL described later, the non-contact layer NL has better magnetic characteristics because of the larger content of the magnetic material (Fe content).

The contact layer CL is included in each of the layer G12, the layer G31, the layer G33, the layer G51, the layer G53, and the layer G71 in the element body layers G1 to G7 shown in FIG. 2. The contact layer CL contains an oxidation-inhibiting material OR that inhibits oxidation of Fe more than the non-contact layer NL (see FIG. 4). As used in the present specification, the expression “inhibiting oxidation of Fe” is intended to mean suppressing formation of an iron oxide from an Fe component that has the highest composition ratio in a composition constituting the contact layer CL, in other words, suppressing oxidation of Fe. By suppressing the formation of an iron oxide in the contact layer CL in contact with the coil conductor CM in this way, adhesion between the contact layer CL and the coil conductor CM can be moderated. Therefore, during the heat treatment of the element body, the vicinity of the contact interface between the contact layer CL and the coil conductor CM is less likely to be affected by a mismatch in shrinkage behavior therebetween. This can reduce cracks in the vicinity of the contact interface.

Specific modes of the oxidation-inhibiting material contained in the contact layer CL will be described below.

### First Mode of Oxidation-Inhibiting Material

As one mode of the oxidation-inhibiting material OR, the oxidation-inhibiting material OR may include Fe-containing particles having the Fe ratio lower than that of Fe-containing particles included in the non-contact layer NL. Specifically, the contact layer CL may contain metal magnetic particles having the Fe ratio lower than that of the non-contact layer NL. By way of example, the contact layer CL may contain an Fe—Si-based alloy or Fe—Si—Cr (chromium)-based alloy, which has the Fe ratio lower than that of the non-contact layer NL. Thus, by increasing the ratio of Si and/or Cr to Fe in the contact layer CL, oxidation of Fe can be prevented because the element (Si and/or Cr) that is more easily oxidized is first oxidized. Further, since Si and/or Cr is contained, the Fe ratio is reduced accordingly, so that the total amount of the oxide film (the amount of iron oxide formed) can also be reduced. Consequently, the formation of an iron oxide can be suppressed in the contact layer CL in contact with the coil conductor CM, thus reducing cracks in the vicinity of the contact interface between the contact layer CL and the coil conductor CM.

Regarding a suitable Fe ratio of the oxidation-inhibiting material OR, the Fe content in the contact layer CL may be lower than the Fe content in the non-contact layer NL by 3% or more and 10% or less (i.e., from 3% to 10%). Specifically, the Fe content (wt %) based on the entirety of the contact layer CL may be lower than the Fe content (wt %) based on the entirety of the non-contact layer NL by 3% or more and 10% or less (i.e., from 3% to 10%). With such an Fe ratio, oxidation of Fe can be suitably suppressed, thereby reducing cracks in the vicinity of the contact interface between the contact layer CL and the coil conductor CM.

Further, regarding the Fe ratio, the Fe content in the contact layer CL may be 50% or more based on the entirety of the contact layer CL. With such an Fe content, a sufficient amount of magnetic material is contained, resulting in better magnetic characteristics.

For example, a method for identifying a material of the oxide layer may include: imaging a cross-section of a sample of a coil component obtained by ion milling, using a scanning electron microscope (SEM) or a transmission electron microscope (TEM); and then identifying the material by compositional analysis or elemental analysis using EDX or the like.

### Second Mode of Oxidation-Inhibiting Material

As another mode of the oxidation-inhibiting material, the oxidation-inhibiting material OR may include Fe-containing particles coated with an insulating coating material. By coating the Fe-containing particles with the insulating coating material, oxidation of the Fe-containing particles can be prevented, thereby reducing cracks in the vicinity of the contact interface between the contact layer CL and the coil conductor CM.

A suitable insulating coating material may contain at least one selected from the group consisting of Si, P, Zn, and Zr. With such an insulating coating material, during heat treatment of the element body, the insulating coating material is more readily oxidized than Fe to form oxides, thereby suitably preventing oxidation of the Fe-containing particles.

### Third Mode of Oxidation-Inhibiting Material

As another mode of the oxidation-inhibiting material, the oxidation-inhibiting material OR may include Fe-containing particles to which a readily oxidizable metal material that is more easily oxidized than Fe is added. The term “readily oxidizable metal material that is more easily oxidized than Fe” as used in the present specification is intended to mean a material having a greater ionization tendency than Fe. When the readily oxidizable metal material is added into the contact layer CL, oxidation can occur in the readily oxidizable metal material, thereby suppressing oxidation of Fe. As a result, oxidation of Fe can be inhibited, thereby reducing cracks in the vicinity of the contact interface between the contact layer CL and the coil conductor CM.

A suitable readily oxidizable metal material is at least one selected from the group consisting of Zn, Zr, Al, and Cr. With such a readily oxidizable metal material, during heat treatment of the element body, the readily oxidizable metal material that is more easily oxidized than Fe is oxidized first to form oxides, thereby suitably suppressing oxidation of Fe.

### Additional Configuration of Element Body

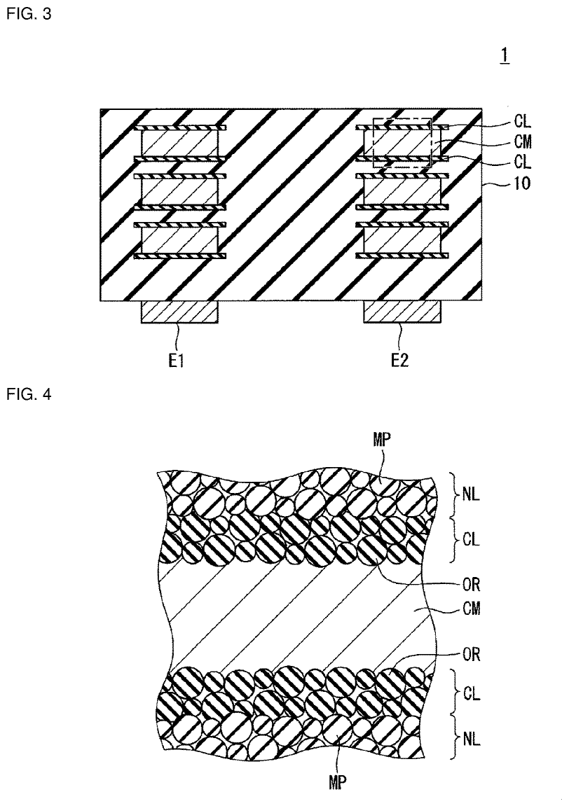

As an additional configuration of the element body, as shown in FIG. 3, the contact layer CL may extend from an outer edge of the coil conductor CM in a direction perpendicular to the stacking direction. In other words, as shown in the perspective plan view of the layer G12, the layer G31, the layer G33, the layer G51, the layer G53, and the layer G71 in FIG. 2, the plane area of the contact layer CL may be designed to be larger than the plane area of the coil conductor CM. With such a configuration, the contact layer CL can appropriately contact the coil conductor CM, thereby appropriately preventing contact between the non-contact layer NL and the coil conductor CM.

### Coil

The coil that includes the plurality of coil conductors CM electrically connected is embedded in the element body. The example shown in FIGS. 2 and 3 indicates a mode in which the coil conductors CM in the element body layers G2, G4, and G6 are electrically connected in the stacking direction to form one coil in the element body. The coil conductors CM in the element body layers G2, G4, and G6 may have the same thickness.

The illustrated example (FIGS. 2 and 3) indicates the mode in which one coil is provided in the element body 10. However, the present disclosure is not limited to this mode. For example, two or more coils may be provided along the stacking direction. Alternatively, a plurality of coils may be arranged side by side in a direction intersecting the stacking direction (the L direction in FIG. 1) within the element body 10 to form a coil array.

A material for the coil conductor CM may be a material having a smaller ionization tendency than Fe. Examples of materials usable for the coil conductor CM may include metal conductors of, for example, Ag, Cu, Au, and alloys thereof. The coil conductor CM may be formed, for example, by printing a conductive paste on the magnetic layer ML described above.

### Outer Electrodes

The outer electrodes E are provided on the mounting surface (first main surface 11) of the element body 10 and are electrically connected to the coil. In the example shown in FIG. 2, the outer electrodes E include the second outer electrode E2 electrically connected to the other end of the coil conductor CM of the element body layer G2, and the first outer electrode E1 electrically connected to the other end of the coil conductor CM of the element body layer G6. Note that the number of outer electrodes is two for one coil. Therefore, if the number of coils is two, the number of outer electrodes may be four.

By way of example, the outer electrodes E may be formed of various materials such as Cu or Ni. The outer electrodes E may be formed as a single layer or may have a multilayer structure of two or more layers. The outer electrodes E may be formed by any method. However, by way of example, the outer electrodes E may be plating electrodes formed by plating (e.g., electroless plating).

### Other Configurations of Coil Component

The through-hole conductors TH may be used for connection between the coil C and the outer electrodes E. That is, the first through-hole conductor TH1 and the second through-hole conductor TH2 may be provided corresponding to the first outer electrode E1 and the second outer electrode E2, respectively. The first through-hole conductor TH1 and the second through-hole conductor TH2 may extend along the stacking direction.

Each via conductor VD may be used for electrical connection between the coil conductors CM in the stacking direction. The via conductor VD may extend along the stacking direction.

Examples of the materials for the first through-hole conductor TH1, the second through-hole conductor TH2, and the via conductor VD may include metal conductors such as Ag and Cu. The material of the first through-hole conductor TH1, the second through-hole conductor TH2, and the via conductor VD may be of the same type as that of the coil conductor CM described above, or may be of a different type. The first and second through-hole conductors and the via conductor may be formed, for example, by forming through-holes in the corresponding magnetic layers ML described above and printing a conductive paste into the through-holes, or by printing a conductive paste for forming the through-hole conductors and the via conductors and then printing each magnetic layer ML on the outside of the conductive paste.

As described above, the coil component 1 of the present embodiment includes the contact layers CL that are in contact with the coil conductors CM and the non-contact layers NL that are not in contact with the coil conductors CM, whereby adhesion between the contact layer CL and the coil conductor CM can be moderated. As a result, the formation of an iron oxide can be suppressed in the contact layer CL in contact with the coil conductor CM, thereby reducing cracks in the vicinity of the contact interface between the contact layer CL and the coil conductor CM.

### Coil Component of Second Embodiment

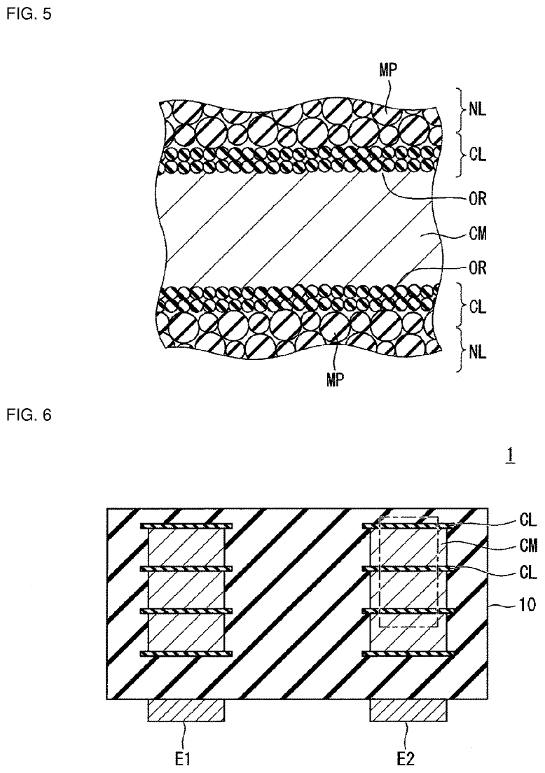

Next, a coil component according to a second embodiment will be described with reference to FIG. 5. Note that, in describing the coil component of the second embodiment, descriptions of features common to the coil component of the first embodiment will be omitted as appropriate. That is, the following description focuses on differences from the coil component of the first embodiment.

As shown in FIG. 5, in the coil component of the second embodiment, the average particle size of a magnetic material containing Fe in the non-contact layer NL (specifically, the average particle size of the metal magnetic particles MP) may be larger than the average particle size of the oxidation-inhibiting material OR. The average particle size may mean an average particle size D50 (particle size corresponding to a cumulative percentage of 50% on a volume basis), as described above. According to the coil component of the second embodiment, the oxidation-inhibiting material OR having a small average particle size can be densely packed between the non-contact layer NL and the coil conductor CM in the stacking direction, thereby reducing cracks in the vicinity of the contact interface between the contact layer CL and the coil conductor CM while preventing contact between the non-contact layer NL and the coil conductor CM.

By way of example, the average particle size of the metal magnetic particles MP included in the non-contact layer NL is about 20 μm or more and about 30 μm or less (i.e., from 20 μm to 30 μm), and the average particle size of the oxidation-inhibiting material OR contained in the contact layer CL is preferably 2 μm or less. In other words, the average particle size of the metal magnetic particles MP included in the non-contact layer NL is preferably 10 times or more than the average particle size of the oxidation-inhibiting material OR contained in the contact layer CL.

### Coil Component of Third Embodiment

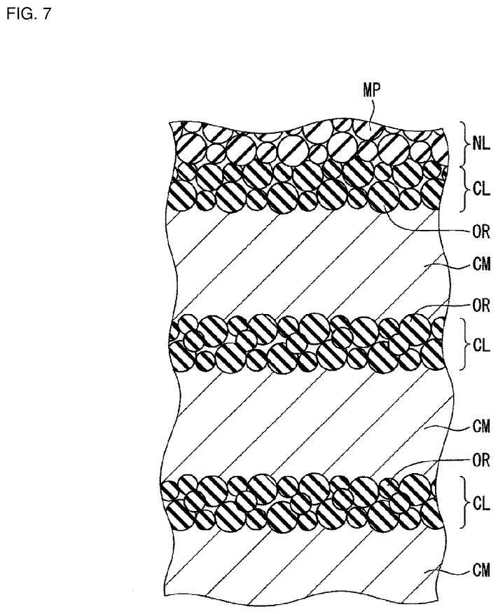

Next, a coil component of a third embodiment will be described with reference to FIGS. 6 and 7. In describing the coil component of the third embodiment, descriptions of features common to the coil component of the first embodiment will be omitted as appropriate. That is, the following description focuses on differences from the coil component of the first embodiment.

As shown in FIGS. 6 and 7, in the coil component of the third embodiment, the contact layer CL and the non-contact layer NL may be disposed in this order on an upper surface of the uppermost coil conductor CM in the stacking direction, while the contact layer CL and the non-contact layer NL may be disposed in this order on a lower surface of the lowermost coil conductor CM in the stacking direction. Meanwhile, only the contact layer CL may be disposed while being sandwiched between these coil conductors CM. Specifically, the coil component of the third embodiment corresponds to a configuration in which the layers G32 and G52 are removed from the coil component shown in FIG. 2. That is, the contact layer CL and the non-contact layer NL on the upper surface of the uppermost coil conductor CM in the stacking direction correspond to the layers G12 and G11, respectively, while the contact layer CL and the non-contact layer NL on the lower surface of the lowermost coil conductor CM in the stacking direction correspond to the layers G71 and G72, respectively.

According to the coil component 1 of the third embodiment, as compared with the coil component 1 of the first embodiment, the product thickness can be reduced by the removal of the layers G32 and G52. Furthermore, the layers G33 and G53 may also be removed. This can further reduce the product thickness.

Moreover, in the coil component of the third embodiment, the oxidation-inhibiting material OR in the contact layer CL may be the oxidation-inhibiting material OR of the second embodiment that has an average particle size of 2 μm or less. By using the oxidation-inhibiting material OR having such an average particle size, the product thickness can be further reduced.

Note that the embodiments disclosed in the present specification are illustrative in all respects and are not to be taken as a basis for limiting interpretation. Therefore, the technical scope of the present disclosure is not to be construed solely based on the above-described embodiments, but shall be defined based on the description of the claims. Furthermore, the technical scope of the present disclosure includes all modifications that fall within the meaning and scope equivalent to those of the claims.

Aspects of the coil component of the present disclosure are as follows.

<1> A coil component including an element body including a magnetic material containing Fe; a coil embedded in the element body; and an outer electrode provided on a mounting surface of the element body and electrically connected to the coil. The coil includes a plurality of coil conductors electrically connected together in a stacking direction. The element body includes a contact layer that is in contact with one of the coil conductors and a non-contact layer that is not in contact with any one of the coil conductors, and the contact layer contains an oxidation-inhibiting material that inhibits oxidation of Fe.

<2> The coil component according to <1>, wherein the oxidation-inhibiting material includes Fe-containing particles having an Fe content lower than an Fe content of Fe-containing particles included in the non-contact layer.

<3> The coil component according to <1> or <2>, wherein an Fe content in the contact layer is lower than an Fe content in the non-contact layer by 3% or more and 10% or less (i.e., from 3% to 10%).

<4> The coil component according to <3>, wherein the Fe content in the contact layer is 50% or more based on an entirety of the contact layer.

<5> The coil component according to any one of <1> to <4>, wherein the oxidation-inhibiting material includes Fe-containing particles coated with an insulating coating material.

<6> A coil component according to <5>, wherein the insulating coating material contains at least one selected from the group consisting of Si, P, Zn, and Zr.

<7> The coil component according to any one of <1> to <6>, wherein the oxidation-inhibiting material includes Fe-containing particles that contain a readily oxidizable metal material, the readily oxidizable metal material being more easily oxidized than Fe.

<8> The coil component according to <7>, wherein the readily oxidizable metal material contains at least one selected from the group consisting of Zn, Zr, Al, and Cr.

<9> The coil component according to any one of <1> to <8>, wherein the contact layer extends from an outer edge of the coil conductor in a direction perpendicular to the stacking direction.

<10> The coil component according to any one of <1> to <9>, wherein the contact layer and the non-contact layer are disposed in this order on an upper surface of one of the coil conductors uppermost in the stacking direction, another contact layer and another non-contact layer are disposed in this order on a lower surface of one of the coil conductors lowermost in the stacking direction, and only the contact layer is disposed in a portion of the element body sandwiched between the coil conductors.

<11> The coil component according to any one of <1> to <10>, wherein an average particle size of the magnetic material containing Fe in the non-contact layer is larger than an average particle size of the oxidation-inhibiting material.

The coil component of the present disclosure can be suitably used as an electronic component that reduces occurrence of cracks in the vicinity of an interface with the coil within the element body.

What is claimed is:

1. A coil component comprising:
an element body including a magnetic material including Fe;
a coil embedded in the element body; and
an outer electrode on a mounting surface of the element body and electrically connected to the coil, wherein
the coil includes a plurality of coil conductors electrically connected together in a stacking direction,
the element body includes a contact layer that is in contact with one of the coil conductors and a non-contact layer that is not in contact with any one of the coil conductors, and
the contact layer includes an oxidation-inhibiting material that inhibits oxidation of Fe.

2. The coil component according to claim 1, wherein
the oxidation-inhibiting material includes Fe-containing particles having an Fe content lower than an Fe content of Fe-containing particles included in the non-contact layer.

3. The coil component according to claim 1, wherein
an Fe content in the contact layer is lower than an Fe content in the non-contact layer by from 3% to 10%.

4. The coil component according to claim 3, wherein
the Fe content in the contact layer is 50% or more based on an entirety of the contact layer.

5. The coil component according to claim 1, wherein
the oxidation-inhibiting material includes Fe-containing particles coated with an insulating coating material.

6. The coil component according to claim 5, wherein
the insulating coating material includes at least one selected from the group consisting of Si, P, Zn, and Zr.

7. The coil component according to claim 1, wherein
the oxidation-inhibiting material includes Fe-containing particles that include a readily oxidizable metal material, the readily oxidizable metal material being more easily oxidized than Fe.

8. The coil component according to claim 7, wherein
the readily oxidizable metal material includes at least one selected from the group consisting of Zn, Zr, Al, and Cr.

9. The coil component according to claim 1, wherein
the contact layer extends from an outer edge of the coil conductor in a direction perpendicular to the stacking direction.

10. The coil component according to claim 1, wherein
the contact layer and the non-contact layer are disposed in this order on an upper surface of one of the coil conductors uppermost in the stacking direction,
another contact layer and another non-contact layer are disposed in this order on a lower surface of one of the coil conductors lowermost in the stacking direction, and
only the contact layer is in a portion of the element body sandwiched between the coil conductors.

11. The coil component according to claim 1, wherein
an average particle size of the magnetic material including Fe in the non-contact layer is larger than an average particle size of the oxidation-inhibiting material.

12. The coil component according to claim 2, wherein
an Fe content in the contact layer is lower than an Fe content in the non-contact layer by from 3% to 10%.

13. The coil component according to claim 2, wherein
the oxidation-inhibiting material includes Fe-containing particles coated with an insulating coating material.

14. The coil component according to claim 3, wherein
the oxidation-inhibiting material includes Fe-containing particles coated with an insulating coating material.

15. The coil component according to claim 2, wherein
the oxidation-inhibiting material includes Fe-containing particles that include a readily oxidizable metal material, the readily oxidizable metal material being more easily oxidized than Fe.

16. The coil component according to claim 3, wherein
the oxidation-inhibiting material includes Fe-containing particles that include a readily oxidizable metal material, the readily oxidizable metal material being more easily oxidized than Fe.

17. The coil component according to claim 2, wherein
the contact layer extends from an outer edge of the coil conductor in a direction perpendicular to the stacking direction.

18. The coil component according to claim 3, wherein
the contact layer extends from an outer edge of the coil conductor in a direction perpendicular to the stacking direction.

19. The coil component according to claim 2, wherein
the contact layer and the non-contact layer are disposed in this order on an upper surface of one of the coil conductors uppermost in the stacking direction,
another contact layer and another non-contact layer are disposed in this order on a lower surface of one of the coil conductors lowermost in the stacking direction, and
only the contact layer is in a portion of the element body sandwiched between the coil conductors.

20. The coil component according to claim 2, wherein
an average particle size of the magnetic material including Fe in the non-contact layer is larger than an average particle size of the oxidation-inhibiting material.
